(19) United States
(12) Patent Application Publication
(10) Pub. No.: US 2024/0167526 A1
(43) Pub. Date: May 23, 2024

(54) DEVICE AND METHOD FOR DETECTING A BRAKING FORCE AND/OR TORQUE AT A BRAKE CALIPER

(71) Applicant: Brembo S.p.A., Curno, Bergamo (IT)

(72) Inventors: Fabio MELDINI, Curno, Bergamo (IT); Andrea MILANESI, Curno, Bergamo (IT); Pietro BARALE, Curno, Bergamo (IT)

(21) Appl. No.: 18/550,304

(22) PCT Filed: Mar. 16, 2022
(86) PCT No.: PCT/IB2022/052363

§ 371 Date: Sep. 13, 2023

(30) Foreign Application Priority Data
Mar. 16, 2021 (IT) 102021000006203

(51) Int. Cl. F16D 66/00; F16D 55/00; F16D 65/00

(52) U.S. Cl. CPC F16D 66/00; F16D 65/0068; F16D 2055/0016; F16D 2066/005

(57) ABSTRACT

A detection device is described for detecting a force acting in a detection portion of a brake caliper and representative of a braking torque acting on the brake caliper when braking. The device is adapted to being mounted between the brake caliper detection portion and a corresponding hub holder by means of fixing and clamping means. When mounted and in the absence of forces acting on it, the detection device is shaped as a washer or plate extending mainly along a reference plane. The device may have a first functional element, a second functional element, a positioning element, and a sensing element.

### FIELD OF THE INVENTION

It is the object of the present invention a force detection device, and a related method, based on sensors capable of supplying electrical or electronic signals.

More specifically, the present invention relates to a device, system and method for detecting a force acting in a detection portion of a brake and for estimating, based on this information, a braking torque acting on the brake caliper when braking.

### BACKGROUND ART

For controlling, monitoring, and actuating a braking system, for example, an electronically controlled disc brake system, it is very useful to know the braking force or torque value applied by the brake calipers of the braking system during a braking action in real-time and as accurately as possible.

However, it is difficult to measure the braking force and/or torque directly, precisely, and reliably, and therefore such value is typically estimated and/or calculated indirectly, with the drawback that such an estimate or calculation does not fully satisfy the necessary precision requirements.

In this regard, there is a tendency in the prior art to determine the braking torque and/or force based on measurements, which are indirect but which refer to quantities closely related to the braking torque and/or force, e.g., forces acting at different points of the brake caliper.

Various types of sensors are interposed between the caliper and the hub holder and exploit various sensing element technologies, e.g., strain meters, optical fibers of MEMS sensors.

These sensors are generally components which, by virtue of the friction phenomenon which develops at the caliper-sensor interface, receive said forces acting at various points of the brake caliper generated during braking, deform and measure said deformation through the sensing elements. The deformation is then converted into strains, by means of which it is possible to determine the braking force and torque (based on mathematical laws during the processing of the acquired signal).

However, it is very complex to make a component which is highly deformable, and thus sensitive to acting forces, and at the same time structurally sound and able to withstand the high stresses of the braking system.

In some known solutions, the sensor may be structurally adequate but not very sensitive (especially at low braking torques, where deformations are limited). In other known solutions, the sensor may be sensitive but fragile.

In view of the above, there is a strong need for devices and methods to detect forces acting on a brake caliper and to estimate a braking torque which overcome the above drawbacks.

In particular, there is a need to overcome the above issues by making a robust sensor which is accurate over a wide range of braking torques, but also easy to make and inexpensive.

### Solution

It is an object of the present invention to provide a detection device for detecting a force acting in a detection portion of a brake caliper and representative of a braking torque acting on the brake caliper when braking, which can at least in part solve the drawbacks described above with reference to the prior art and respond to the aforesaid needs particularly felt in the considered technical sector.

These and other objects are achieved by a detection device according to claim 1.

Some advantageous embodiments of such device are the subject of dependent claims 2-23.

It is a further object of the present invention to provide a system for detecting a force acting in a detection portion of a brake caliper, employing the aforementioned device.

These and other objects are achieved by a detection system according to claim 24.

It is a further object of the present invention to provide a method for detecting a force acting in a detection portion of a brake caliper and representative of a braking torque acting on the brake caliper when braking.

These and other objects are achieved by a method according to claim 25.

It is a further object of the present invention to provide a brake caliper system having brake force estimation functionality, employing the above device.

This and other objects are achieved by a system for determining a braking force and/or torque according to claim 26.

Some advantageous embodiments of said brake caliper system are the object of the dependent claims 27-28.

### BRIEF DESCRIPTION OF THE DRAWINGS

Further features and advantages of the devices, methods, and systems according to the invention will become apparent from the following description of preferred embodiments thereof, given by way of non-limiting example, with reference to the accompanying figures, in which:

FIG. 1 is a perspective view of a detection device, according to an embodiment comprised in the invention;

FIGS. 2 and 3 (3 and 3A) respectively show exploded perspective view and a number of orthogonal views of the device in FIG. 1;

FIG. 4 shows some side views of a detection device, according to an embodiment comprised in the invention;

FIGS. 5-7 illustrate respective embodiments of a brake caliper system according to the invention, and show the mounting of detection devices in the brake caliper;

FIGS. 8A and 8B illustrate further details and geometrical aspects of the embodiment of the system to which FIG. 7 also refers.

### DETAILED DESCRIPTION OF THE INVENTION

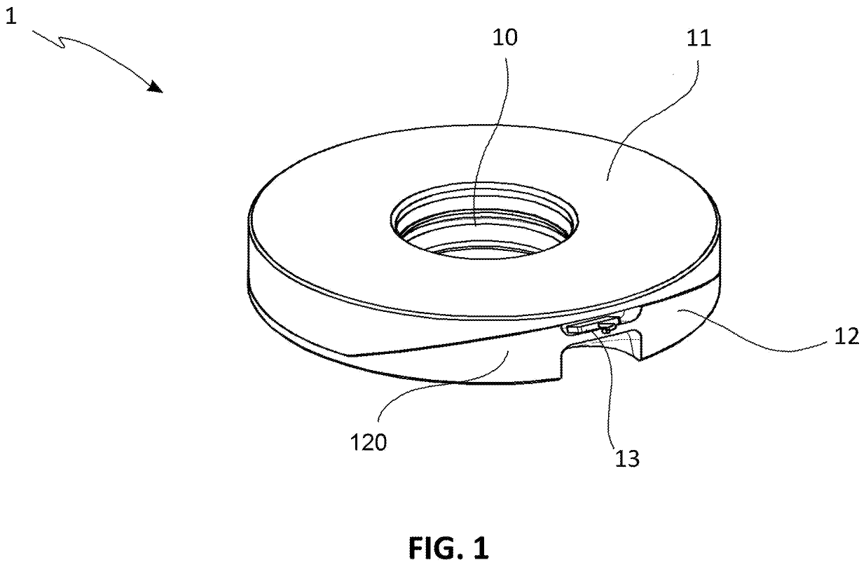

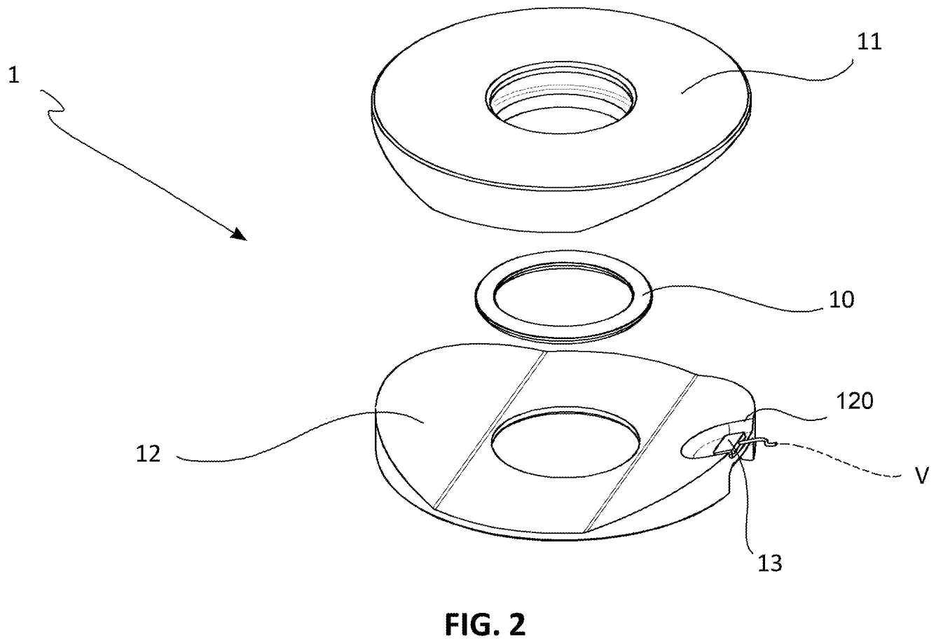

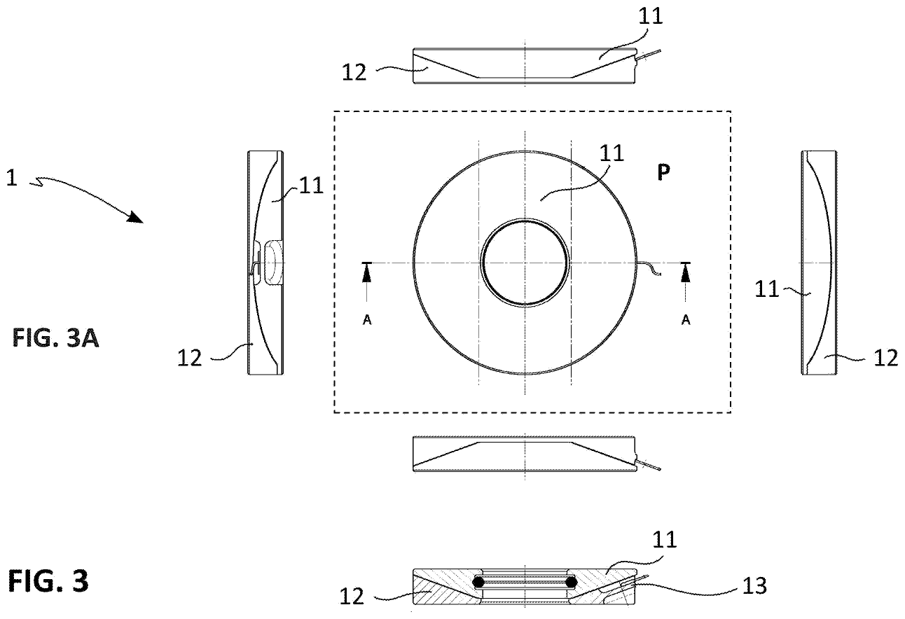

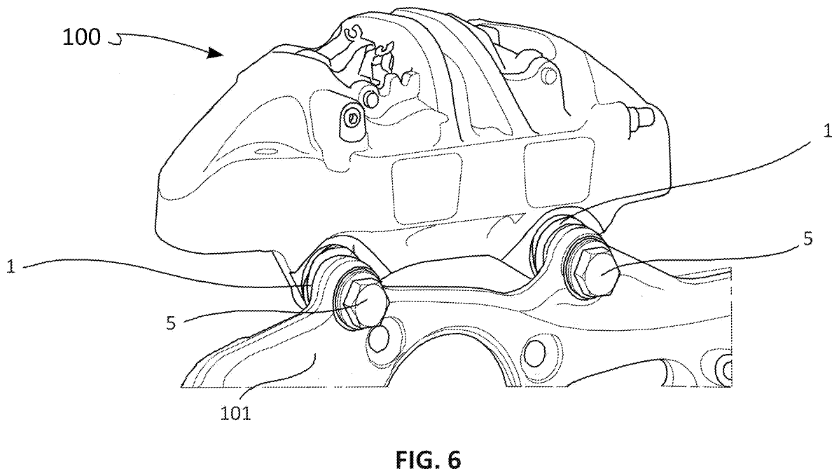

A detection device 1 for detecting a force acting in a detection portion Z of a brake caliper 100 and representative of a braking torque acting on the brake caliper during braking is now described with reference to FIGS. 1-7 and 8A-8B.

The device 1 is adapted to being mounted between said brake caliper detection portion Z and a corresponding hub holder (i.e., hub carrier) 101, by means of fixing and clamping means 5.

The detection device 1, when mounted, and in absence of forces acting on it, is shaped like a washer or plate (e.g., discoidal, polygonal, or another shape) extending mainly along a reference plane P.

The device 1 comprises a first functional element 11, a second functional element 12, a positioning element 10, and a sensing element 13.

The first functional element 11 is adapted to be placed in close contact with the brake caliper detection portion Z when the device 1 is mounted, so as to be subjected to (i.e., to sustain), due to friction, a force representative of the braking force acting on said brake caliper detection portion Z.

The second functional element 12 is adapted to be placed in close contact with the hub holder 101 when the device 1 is mounted.

The positioning element 10 is connected to the first functional element 11, and adapted to be connected to the clamping and fixing means 5, when the device 1 is mounted, so as to ensure that the mounted device is arranged in the working position between the hub holder 101 and the brake caliper detection portion Z.

The first functional element 11 is arranged, relative to the second functional element 12, to come into sliding contact with the second functional element 12 and to slide relative to the second functional element 12, when the first functional element is subjected to a force, when braking, due to the friction with the brake caliper detection portion (without hindrances by the fixing and clamping means 5), so as to consequently transfer a force, dependent on the aforesaid force sustained by the first functional element 11 and representative of the braking force acting on the caliper detection portion Z, to a surface of the second functional element 12 which stops the sliding of the first functional element 11 and comprises a deformable portion 120, adapted to deform depending on the force applied on it.

The sensing element 13 is housed in the aforesaid deformable portion 120 of the second functional element 12 and configured to detect the force transferred onto it by the first functional element 11 on the deformable portion, or a quantity related to said force (e.g., a strain and/or a deformation), and to generate at least one electrical signal V dependent on the force (or on the quantity related to said force) detected by the sensing element 13 and representative of the braking force acting on the detection portion of the brake caliper Z.

According to an implementation option, the positioning element 10 is inserted into a groove formed in the first functional element 11. When the device is mounted, the positioning element 10 allows the first functional element 11 to maintain an appropriate distance from the fixing and centering means. By means of this appropriate distance, when a force acts on the first function element 11, its sliding on the function element 12 is not prevented by the fixing and centering elements.

According to an embodiment of the device, the positioning element 10 is a centering element characterized by high deformability and low modulus of elasticity, and is configured to substantially cancel or minimize or significantly reduce the transfer of the force sustained by the first functional element 11 to the fixing and/or clamping means 5 so that the force and/or load sustained by the first functional element 11 is nearly entirely transferred to the deformable portion of the second functional element 12.

According to an embodiment of the device, the first functional element 11 is a half-washer-shaped element, having a first element first face and a first element second face, and the second functional element 12 is an element shaped as a semi-washer having a second element first face and a second element second face.

The first element first face is substantially flat, parallel to the reference plane P, is adapted to be placed in close contact with the detection portion of the brake caliper Z, and to undergo by friction a force representative of the braking force acting on the detection portion Z.

The first element second face is opposite to the first element first face, and has at least one inclined or perpendicular portion relative to the reference plane (P). In several possible implementation options, the aforementioned inclination assumes a value of less than 90° or a value of 90° (in the case of perpendicularity).

The flat second element first face is parallel to the reference plane P and is adapted to be placed in close contact with the hub holder 101.

The second element second face is opposite to the second element first face and has at least one inclined or perpendicular portion relative to the reference plane P. Again, in this case, in several possible options of implementation, the aforementioned inclination assumes a value of less than 90° or a value of 90° (in the case of perpendicularity).

In any case, the inclination of the second element second face has an inclination, which is complementary to the inclination of the inclined portion of the first element second face.

The aforesaid first functional element 11 and said second functional element 12 are arranged so that, when said device 1 is mounted, in the absence of forces acting on the device 1, the portion of the first element second face parallel to said reference plane P is in contact with the portion of the second element second face parallel to the reference plane P, and in the presence of forces acting on the device 1, by friction due to braking, the inclined portion of the first element second face also comes into contact with the inclined portion of the second element second face, thus transferring the force deriving from the force sustained by the first functional element.

According to an implementation option, the inclined portion of the second element second face comprises the aforesaid deformable portion in which said sensing element is housed.

The aforesaid inclined surfaces are used to break down a purely unidirectional force into two components which increase the deformation of the measurement zone.

According to an implementation option, net of tolerances, the aforesaid surfaces have the same inclination to ensure a homogeneous load distribution on the surface. Indeed, if the force were applied to a limited portion, the mechanical strength of the device could be compromised.

The inclination of the inclined portion of the first element second face and the inclined portion of the second element second face is a compromise between ensuring mechanical strength and ensuring a detectable state of strain and/or deformation in the zone in which the sensing element is placed.

According to an implementation option, the first element first face and the second element first face, intended to be placed in contact with the brake caliper detection portion Z and the hub holder 101, respectively, are either knurled or machined so as to stabilize and maximize friction and prevent sliding.

According to an implementation option, the first functional element 11 comprises a housing for the positioning element 10.

According to an embodiment, the device 1 further comprises a deformable connection element configured to connect the first functional element 11 and the second functional element 12. In this case, said deformable connecting element constitutes the aforesaid deformable portion in which the sensing element is housed.

According to different possible implementation options, the aforesaid deformable connecting element is comprised either in the first functional element 11 or in the second functional element 12 or is a third element extraneous to both the first element 11 and the second element 12.

According to further possible implementation options, the first functional element 11, the second functional element 12, and the deformable connection element are integrated into a single element. In such a case, the aforementioned deformable connection element may be viewed as part of both functional elements 11 and 12.

According to an implementation option, the aforesaid deformable connection element is in the form of a bridge or thin foil.

According to an embodiment of the device, the aforesaid deformable portion is shaped as a highly deformable bridge or thin foil and is arranged in the aforesaid highly biased zone of the second functional element 12.

According to an embodiment of the device, the positioning element 10 is an annular-shaped element, adapted to be arranged in a housing obtained in the functional element 11.

According to an implementation option, the aforesaid first functional element 11 and the second functional element 12 are made of steel.

According to another implementation option, the first functional element 11 and the second functional element 12 are made of titanium or aluminum or other material adapted to a maximum load provided during the device design.

According to an implementation option, the positioning element 10 is made of EPDM.

According to another implementation option, the positioning element 10 is made of rubber or peek or graphite or any highly deformable element having a low modulus of elasticity.

According to an embodiment of the device, the sensing element 13 is a deformation or strain sensor, adapted to provide a signal representative of the detected deformation or strain, wherein the detected deformation or strain is, in turn, representative of the force acting on the sensor.

According to a possible embodiment of the device, the sensing element 13 is any mechanical, optical, acoustic, electrical force, or strain sensor.

It is worth noting that the term sensor refers to a component capable of correlating an electrical signal to the variation of a physical quantity, the variation of the electrical signal being directly correlated to a corresponding mechanical magnitude.

For example, typically, by measuring the deformation of a component in a well-defined region and knowing the mechanical characteristics of the material, an electrical signal is obtained through which the mechanical load present in the region in which the sensor is installed can be traced.

To make the measurement more precise, an implementation option provides integrating a thermocouple which detects the temperature of the reading area to compensate for the signals and take into account the change in mechanical properties of the material at temperature.

According to a different implementation option, the sensing element 13 is a fiber optic sensor, or a MEMS sensor, or a piezoresistive sensor, or a resonator sensor on silicon.

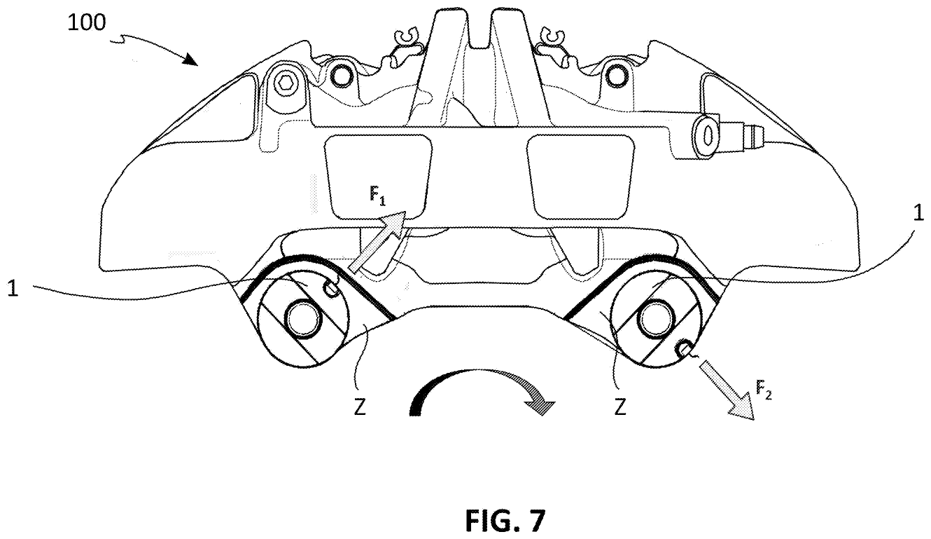

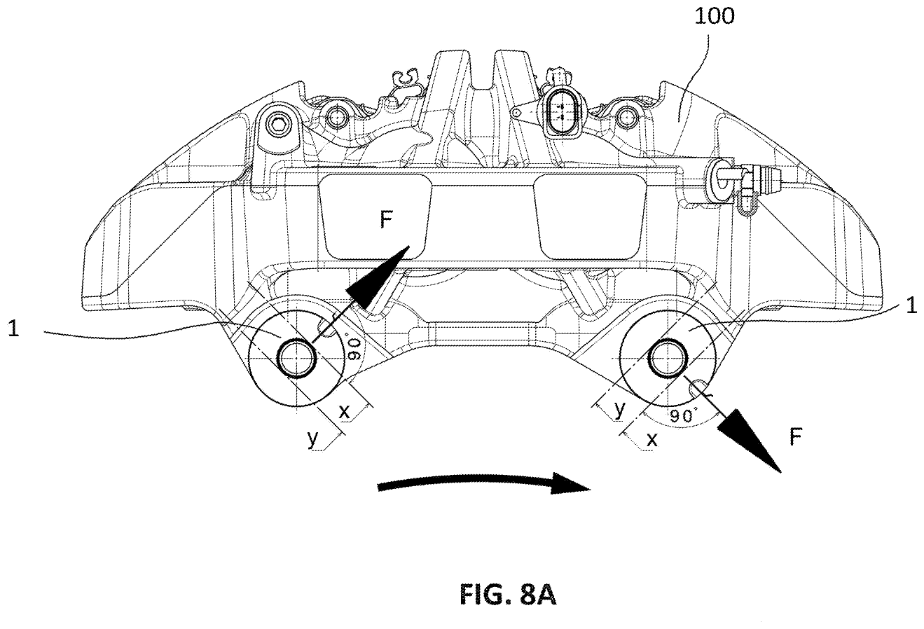

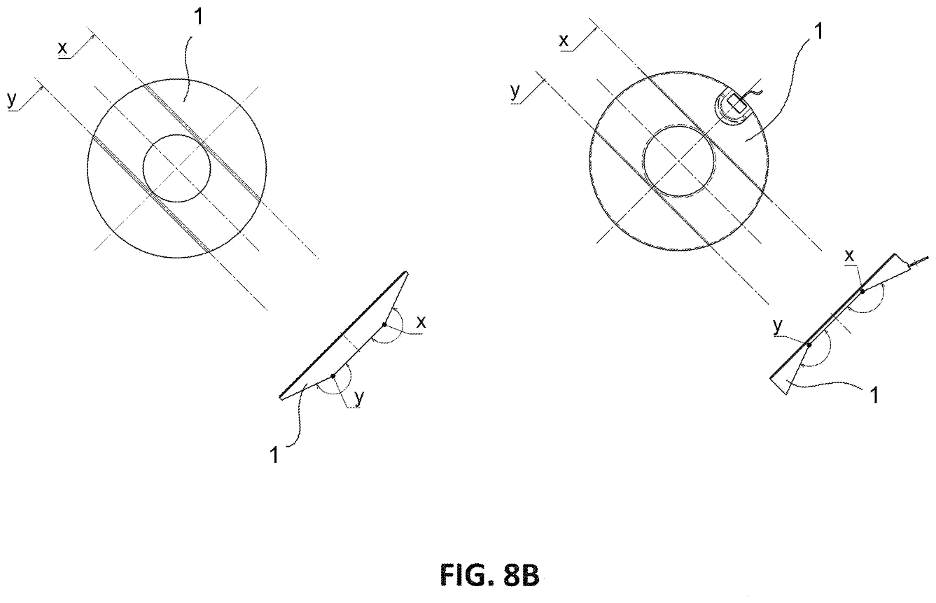

According to an embodiment of the device, the x- and y-axes which generate the inclined surfaces (i.e., the x- and y-axes which define the plane of the inclined surfaces) of the first functional element second face and second functional element second face are oriented in a direction defined in the phase of design as being substantially orthogonal to the direction of the forces which are expected to be generated as a result of braking (as shown in FIG. 7, and, more in detail, in FIGS. 8A and 8B). This maximizes the normal load which is transmitted to the inclined surface of the second element face, promoting deformation of the zone in which the sensing element lies.

According to an embodiment of the device, at least one of the first element second face and the second element second face, intended to be put in contact with each other to make possible the sliding between the first element 11 and the second element 12, is coated with anti-friction coatings, such as DLC, Teflon or the like, in order to reduce friction and promote sliding.

According to an implementation option, the sensing element 13 is comprised in a deformable part of the first functional element 11.

According to another implementation option, both the first functional element 11 and the second functional element comprise a respective deformable part, wherein a respective sensing element 13 is inserted.

According to an embodiment of the device, the first functional element 11 and/or the second functional element 12 comprise a plurality of deformable portions, in which a respective plurality of sensing elements 13 is inserted, to have a plurality of respective force detections which make it possible to improve the estimation of the acting force and/or to detect the force under different driving conditions (e.g., forward, reverse).

According to an embodiment, the device 1 further comprises at least one temperature sensor, configured to provide temperature information useful for performing temperature compensations adapted to improve the detected force measurement and the braking torque estimation.

As noted above, in an embodiment of the device, the device 1 is composed of two paired blocks that are free to slide over each other by virtue of a specially calibrated clearance between the parts. Indeed, the sliding must be allowed, but no element of the sensor must come into contact with the fixing screw, except for the highly deformable positioning element.

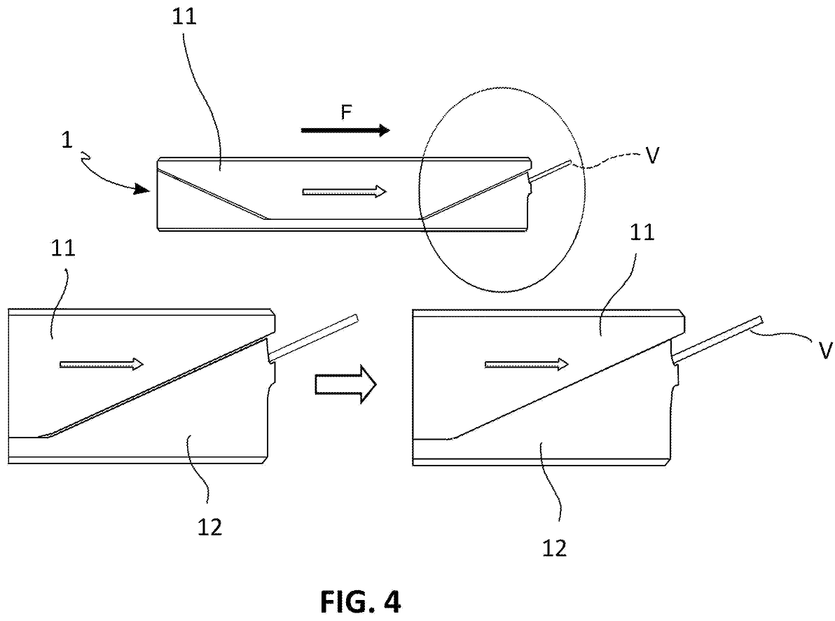

The half-washer on the caliper side receives the braking force from the caliper by virtue of the friction phenomenon. The knurling prevents local variations in the friction coefficient and micro-slip phenomena between the device and the caliper, which can occur following a change in the direction of travel of the vehicle. This block is then free to translate on the one underneath until it meets the inclined surface of the half-washer in contact with the hub holder (as shown in FIG. 4). The latter is also knurled at the interface with the hub holder to prevent slippage.

When the inclined surfaces of the two blocks come into contact, the transmission of the load takes place, which is entirely conveyed onto a circumscribed surface subjected to high deformation.

In an implementation option, a thin bridge is built into the hub holder side half-washer at the most stressed and deformed zone, which serves as a highly deformable element and as a housing for the sensing element. By virtue of this configuration, the load is no longer dispersed in the structure of the entire sensor but is confined to the reading zone of the sensing element.

It is important that the sliding of the half-washers never induces contact with the fixing screw. If this were the case, the load would be transmitted to the screw, shear stressing it dangerously and making the sensor ineffective. To overcome this problem, according to an implementation option of the device, the clearance between the half-washers is calculated specifically. Furthermore, a positioning element, or centering element, is introduced into a groove in the caliper side half-washer around the screw. The latter, as previously illustrated, is characterized by a low elastic modulus and does not transmit load to the screw during operation.

It has been demonstrated through FEM simulations and experimental tests that this sensor device, especially at the deformable bridge, is extensively biased.

Sensitivity analysis determined that, by means of such a device, it is possible to appreciate a significant variation of strains between the minimum and maximum braking torque conditions.

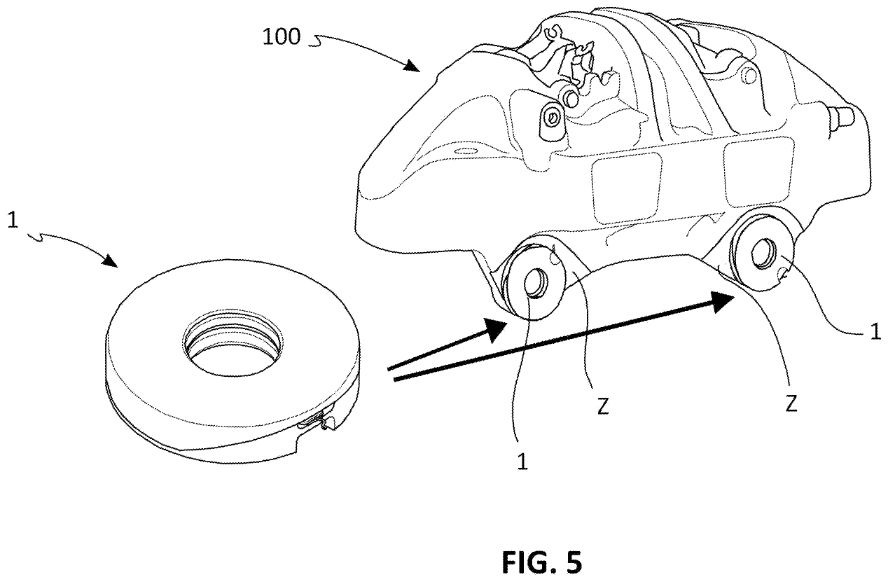

A system for detecting a force acting in a detection portion Z of a brake caliper 100 and representative of a braking torque acting on the brake caliper during braking, according to the present invention, will now be described with reference to FIGS. 5-7 and 8A-8B.

This system comprises a detection device 1 according to any one of the previously illustrated embodiments of the device, and further comprising electronic processing means configured to determine said braking force and/or torque based on the at least one electrical signal V provided by the at least one sensing element 13 of the device 1.

It is described here below a method for detecting a force acting in a detection portion Z of a brake caliper 100 and representative of a braking torque acting on the brake caliper upon braking, according to the present invention.

Said method firstly comprises the step of securely fixing, by means of supporting and fixing means 5, at least one detection device 1 to a respective detection portion Z at the brake caliper 100. Said at least one detection device 1 is a detection device according to any one of the previously illustrated embodiments of the device.

The method further comprises detecting, by a sensing element 13 comprised in the device 1, a force or force-related quantity acting in the detection portion Z in which the device 1 is located and generating, by the sensing element 13, at least one electrical signal V dependent on the force (or on force-related quantity) detected by the sensing element 13 and representative of the braking force acting on the detection portion Z.

The method finally comprises the steps of providing the aforesaid at least one electrical signal V to electronic processing means, and determining, by said electronic processing means, the braking torque acting on the brake caliper during a braking operation, based on the aforesaid at least one electrical signal V.

A brake caliper system having brake force estimation functionality is described herein, according to the present invention.

Such a system comprises a brake caliper 100, having a brake caliper body and at least one detection zone Z at a respective attachment point to the hub holder 101, and comprises a detection device 1 mounted and fixed between said brake caliper detection portion Z and a corresponding hub holder 101, by means of fixing and clamping means 5. Said at least one detection device 1 is a detection device according to any one of the previously illustrated embodiments of the device.

According to an embodiment, the system comprises at least two detection devices 1 at the two attachment points between the brake caliper and the hub holder.

According to an embodiment, the system further comprises electronic processing means operatively connected to at least one detection device 1 to receive at least one respective electrical signal V generated by at least one respective sensing element 13 comprised in the respective device 1.

Such electronic processing means are configured to determine the braking torque acting on the brake caliper when braking, based on said at least one electrical signal V.

As it may be noticed, the object of the present invention is fully achieved by the devices, systems, and methods described above, by virtue of the functional and structural features thereof.

As described above, the device and method according to the invention provide an effective solution for real-time braking torque detection. Knowing the braking torque value in real-time is useful to implement control logic on advanced braking systems, as well as to evaluate the intensity of the residual torque phenomenon.

The sensor device is interposed between hub holder and caliper and can be adapted to both axial and radial-mount calipers. It allows the passage of the fixing screws inside it.

The detection device shown above can detect the force acting in one or more detection zones of the brake caliper with good accuracy.

Furthermore, such a device, by virtue of its small size and its “washer” shape, can be advantageously and easily inserted between the hub holder and the caliper using already provided fixing means (for example, the screws already provided for the attachment of the brake caliper to its support, one or more attachment points).

Furthermore, the aforementioned detection device, by virtue of the structural characteristics described, can provide force measurements with high precision over a wide dynamic range, ranging from very high forces (e.g., due to a high braking torque, as in an emergency braking) to, at the opposite extreme, very low forces (e.g., due to residual torques acting on the braking system).

Other advantages of the device are compactness, robustness, ease of installation (e.g., using the fixing systems already provided for fixing the brake caliper), and versatility of use in the context of fixed or floating caliper disc brakes.

Similar advantages are obtained with the detection system and method, and the brake caliper system with brake force estimation functionality at the brake caliper described above.

The aforesaid features allow precise measurements of forces acting at one or more sensing points, e.g., of a brake caliper, which is in itself very useful, in general, for many applications in the electronic control of a brake system.

As noted above, among the most useful applications is the estimation and/or determination of the braking force and/or torque acting in real-time during a braking operation.

To meet contingent and specific needs, the person skilled in the art may make several changes and adaptations to the above-described embodiments and may replace elements with other functionally equivalent ones, without however departing from the scope of the following claims. All the features described above as belonging to one possible embodiment may be implemented independently from the other described embodiments.

1-20. (canceled)

21. A detection device for detecting a force acting in a detection portion of a brake caliper and representative of a braking torque acting on the brake caliper when braking, adapted to being mounted between said brake caliper detection portion and a corresponding hub holder, by means of fixing and clamping means,
wherein the detection device, when mounted, and in the absence of forces acting on it, is shaped as a washer or plate mainly extending along a reference plane,
wherein the device comprises:
a first functional element, adapted to be placed in close contact with the brake caliper detection portion, when the device is mounted, so as to be subjected, due to friction, to a force representative of the braking force acting on said brake caliper detection portion;
a second functional element, adapted to be placed in close contact with the hub holder when the device is mounted;
a positioning element, connected to said first functional element, and adapted to be connected to the clamping and fixing means, when the device is mounted, so as to ensure that the mounted device is arranged in the working position between the hub holder and the brake caliper detection portion,
wherein the first functional element is arranged, relative to the second functional element, to come into sliding contact with the second functional element and to slide relative to the second functional element, when the first functional element is subjected to a force, when braking, due to the friction with the brake caliper detection portion, so as to consequently transfer a force, dependent on said force sustained by the first functional element and representative of the braking force acting on the caliper detection portion, to a surface of the second functional element which stops the sliding of the first functional element and comprises a deformable portion, adapted to deform depending on the force applied on it;
a sensing element, housed in said deformable portion of the second functional element and configured to detect the force transferred by the first functional element onto the deformable portion, or a quantity related to said force, and to generate at least one electrical signal dependent on the force, or on the quantity related to said force, detected by the sensing element and representative of the braking force acting on the caliper detection portion.

22. A detection device according to claim 21, wherein the positioning element is a centering element characterized by high deformability and low modulus of elasticity, and is configured to minimize or significantly reduce the transfer of the force sustained by the first functional element to the fixing and/or clamping means so that the force sustained by the first functional element is substantially entirely transferred to the deformable portion of the second functional element.

23. A detection device according to claim 21, wherein:
the first functional element is a half-washer-shaped element, having a substantially flat first element first face, parallel to the reference plane, adapted to be placed in close contact with the brake caliper detection portion, and to be subjected, due to friction, to a force representative of the braking force acting on the detection portion, and a first element second face, opposite to the first element first face and having at least one portion either inclined or perpendicular relative to the reference plane;
the second functional element is a half-washer-shaped element, having a flat second element first face, parallel to the reference plane, adapted to be placed in close contact with the hub holder, and a second element second face, opposite to the second element first face, having at least one portion either inclined or perpendicular relative to the reference plane, with an inclination complementary to the inclination of the inclined portion of the first element second face,
wherein said first functional element and said second functional element are arranged so that, when said device is mounted, in the absence of forces acting on the device, the portion of the first element second face parallel to said reference plane is in contact with the portion of the second element second face parallel to the reference plane, and in the presence of forces acting on the device, by friction due to braking, the inclined portion of the first element second face also comes into contact with the inclined portion of the second element second face, transferring the force deriving from the force sustained by the first functional element;
wherein said inclined portion of the second element second face comprises said deformable portion in which said sensing element is housed.

24. A detection device according to claim 23, wherein the first element first face and the second element first face, intended to be placed in contact with the brake caliper detection portion and the hub holder, respectively, are either knurled or machined to maximize friction and prevent sliding,
and/or wherein the first functional element comprises a housing for the positioning element.

25. A detection device according to claim 21, wherein the detection device further comprises a deformable connection element, configured to connect the first functional element and the second functional element, wherein said deformable connection element constitutes said deformable portion in which said sensing element is housed,
or wherein the detection device further comprises a deformable connection element, configured to connect the first functional element and the second functional element, wherein said deformable connecting element is comprised either in the first functional element or in the second functional element, or is part of both, or is a third element extraneous to both the first functional element and the second functional element.

26. A detection device according to claim 21, wherein the first functional element, the second functional element and the deformable connection element are integrated into a single element.

27. A detection device according to claim 21, wherein said deformable portion or said deformable connecting element is shaped as a bridge or thin foil,
or wherein the deformable portion is shaped as a highly deformable bridge or thin foil and is arranged in a highly biased area of the second functional element.

28. A detection device according to claim 21, wherein the first functional element, the second functional element are made of steel,
or wherein the first functional element and the second functional element are made of titanium or aluminum or other material adapted to a maximum load provided in the design phase.

29. A detection device according to claim 21, wherein the positioning element is made of EPDM,
or wherein the positioning element is made of rubber or peek or graphite or any highly deformable element having a low modulus of elasticity.

30. A detection device according to claim 21, wherein the sensing element is a deformation or strain sensor, adapted to provide a signal representative of the detected deformation or strain, wherein the detected deformation or strain is, in turn, representative of the force acting on the sensor,
or wherein the sensing element is any of mechanical, optical, acoustic, electrical force or strain sensor,
or wherein the sensing element is a fiber optic sensor, or a MEMS sensor, or a piezoresistive sensor, or a resonator sensor on silicon.

31. A detection device according to claim 21, wherein the x- and y-axes which generate the inclined surfaces of the first functional element second face and second functional element second face are oriented in a direction defined in the design phase as being substantially orthogonal to the direction of the forces which are expected to be generated as a result of braking.

32. A detection device according to claim 21, wherein at least one of the first element second face and the second element second face, intended to be placed in contact with each other to promote the sliding between the first element and the second element, is coated with anti-friction coatings, such as DLC, Teflon or the like, to reduce friction and promote sliding.

33. A detection device according to claim 21, wherein the sensing element is comprised in a deformable part of the first functional element.

34. A detection device according to claim 33, wherein both the first functional element and the second functional element comprise a respective deformable part, wherein a respective sensing element is inserted,
or wherein the first functional element and/or the second functional element comprise a plurality of deformable portions, in which a respective plurality of sensing elements is inserted, to have a plurality of respective force detections which make it possible to improve the estimation of the acting force and/or to detect the force under different driving conditions.

35. A detection device according to claim 21, further comprising at least one temperature sensor, configured to provide temperature information useful for performing temperature compensations adapted to improve the detected force measurement and the braking torque estimation.

36. A system for detecting a force acting in a detection portion of a brake caliper and representative of a braking torque acting on the brake caliper when braking, comprising a detection device according to claim 21, and further comprising electronic processing means configured to determine said braking force and/or torque based on the at least one electrical signal provided by the at least one sensing element of the device.

37. A method for detecting a force acting in a detection portion of a brake caliper and representative of a braking torque acting on the brake caliper when braking, wherein the method comprises the steps of:
securely fixing, by means of supporting and fixing means, at least one detection device to a respective detection portion at the brake caliper,
wherein said at least one detection device is a detection device according to claim 21;
detecting, by a sensing element comprised in said device, a force or a quantity correlated to the force acting in the detection portion in which said device is placed;
generating, by the sensing element comprised in said device, at least one electrical signal dependent on the force or on the force-related quantity, detected by the sensing element, and representative of the braking force acting on the detection portion;
providing said at least one electrical signal to electronic processing means;
determining, by means of electronic data processing means, the braking torque acting on the brake caliper when braking, based on said at least one electrical signal.

38. A brake caliper system with brake force estimation functionality, comprising:
a brake caliper, having a brake caliper body and at least one detection zone at a respective attachment point to the hub holder;
at least one detection device mounted and fixed between said brake caliper detection portion and the corresponding hub holder, by means of fixing and clamping means, wherein said at least one detection device is a detection device according to claim 21.

39. A brake caliper system according to claim 38, comprising at least two detection devices at two respective attachment points between brake caliper and hub holder.

40. A brake caliper system according to claim 38, further comprising electronic processing means operatively connected to at least one detection device to receive at least one respective electrical signal generated by at least one respective sensing element comprised in the respective device,
wherein said electronic processing means are configured to determine the braking torque acting on the brake caliper when braking, based on said at least one electrical signal.
